(19) United States
(12) Patent Application Publication
(10) Pub. No.: US 2006/0031040 A1
(43) Pub. Date: Feb. 9, 2006

(54) System for real-time contaminant detection in a water distribution system

(76) Inventor: Thomas D. Wolfe, Rough & Ready, CA (US)

Correspondence Address: MCHALE & SLAVIN, P.A., 2855 PGA BLVD, PALM BEACH GARDENS, FL, 33410, US

(21) Appl. No.: 10/911,236

(22) Filed: Aug. 3, 2004

(51) Int. Cl. G06F 11/30

(52) U.S. Cl. 702/184

(57) ABSTRACT

A system for monitoring water quality at remote locations in a water distribution system using water sensors installed at end user sites to detect contaminants downstream in the distribution system. Each sensor includes an integral processing means and a communications interface allowing the sensor to be coupled to a a remotely located Internet server via telephone lines at the end user site. The sensor assemblies are effective for measuring critical water parameters, processing measured data to provide quantified output data, and transmitting the output data to the Internet server in real time. A processor resident on the Internet server is operable to compare the output data with pre-established safe water parameters, determine differentials between pre-established safe water parameters and the output data, and issue an Alarm Event report if known limits for the differentials are exceeded. The Alarm Event report can be automatically transmitted to Department of Homeland Security.

### FIELD OF THE INVENTION

This invention is related in general to the field of water distribution systems, and more particularly to a method of remote monitoring of quality at end user sites through a global computer network using sensors having integral processing and communication means.

### BACKGROUND OF THE INVENTION

Recent events have made protection of water supplies from deliberate contamination an increasingly important concern. The water supply infrastructure has long been recognized as being potentially vulnerable to terrorist attacks, including physical disruption, bioterrorism/chemical contamination, and cyber attack. Damage or destruction by terrorist attack could disrupt the delivery of vital human services, threaten public health and the environment, and possibly cause loss of life. While there exist many different devices and methods to analyze water for contaminants, widespread deployment of such devices is expensive and difficult.

Much of the public concern is focused on the safety of water reservoirs and treatment plants. If the deliberate contamination of a public water supply were to be contemplated, it would highly unlikely this could be accomplished at the source, for example, by introducing large amounts of a biological or chemical agent into a main reservoir. Most reservoirs hold between 3 million and 30 million gallons of water, which would significantly dilute any contaminants to the point that terrorists would have to release enormous quantities to do serious damage. Also, most of the contaminants would be destroyed or neutralized when the water is processed at a water treatment plant. Most water treatment and distribution systems rely on the introduction and maintenance of a disinfectant into the water system to protect against contamination by biological as well as chemical agents. Chlorine, in the form of gas or hypochlorite, is by far the most common material used for this purpose, and kills or inactivates viruses as well as bacteria like E. coli and salmonella. However, substitutes such as chloramines, ozone, hydrogen peroxide, peracetic acid, chlorine dioxide, and various mixed oxides also find service in this application. All of these materials have a more or less common mode of action. Some plants also treat water with ozone, which is more effective in killing protozoa. In most facilities, the water is also filtered to move particles larger than one micron in size, which eliminates the threat from anthrax and botulism spores. The reaction rates of the various disinfection compounds are reasonably well known and well characterized.

In terms of real vulnerabilities, however, the actual danger may be the pipes that carry the water, not the facilities that store or purify it. A more feasible scenario of terrorist activity may well involve the introduction of contaminants from an end user site, such as a private residence or business, where contaminants can be surreptitiously pumped into the main water line to affect end users located downstream in the distribution system. This can be accomplished by reversing the flow of water into a home or business using simple tools such as a pressure washer or a bicycle pump, and using the resulting “backflow” to push poisons outward into the water distribution system.

To respond to the threats of terrorism in drinking water supplies, sensors have been and are being introduced into the distribution system to continuously monitor selected contaminants in the drinking water supply. For example a system may monitor free chlorine residual at a location in the distribution system downstream of the main treatment plant. However, the concentration of free chlorine present at this point in the distribution system may lag the free chlorine analyzed at the exit of the water treatment plant by hours or even days in some cases. The lag will also vary by time of day, since water demand follows well known 24 hour cyclical periods.

Applicant's invention registered as U.S. Pat. No. 6,332,110 teaches the use of a remote monitoring system to monitor the performance of an advanced separation process, particularly as related to water treatment. Many of the analytical devices used to continuously monitor water treatment operations are based on advanced separation processes employing selective ion membranes which concentrate the analyte for the detector apparatus. For example, detection of chlorine may be mediated via a membrane which readily and specifically passes free chlorine or hypochlorous acid (HCIO), thus separating the analyte (the chlorine or chlorine containing compounds) from the bulk solution and concentrating it. The detector apparatus may also incorporate multiple sensors and analyzers on a single unit. The multiple units are usually electronically controlled. The control system usually features output methods allowing the display and storage of collected data.

Deploying a range of sensor systems in the field provides a means to analyze for contaminants but does not provide for reporting and subsequent analysis of the data. Reporting and analysis of data in real time, or near real time, would provide the optimal security in the event of water contamination, either deliberate or otherwise. Rapid reporting of the data to a facility readily accessible by the management or operators of the utility or distribution system and subsequent analysis of the data is very important to by providing quick response. Ideally, data can be transmitted over a communications network such as the Public Switched Telephone Network (PSTN), or a wireless (cellular) communication network. The PSTN is arguably a more reliable mode of transmission than cellular networks, however using the PSTN would require installing the necessary wiring and equipment at key junctions in the water distribution system, which may be expensive, difficult, or impossible depending on the location. The instant invention provides a method of installing sensor assemblies, inclusive of a microprocessor and communications interface, into water lines at end user sites, such as private residences, businesses, public buildings, etc. In this way, existing PSTN wiring can be used for communication with a central data collection server.

The instant invention also provides a means of rapidly aggregating the information at a central location in a form readily accessible to authorized users such as the Department of Homeland Security. It further provides a means to employ sophisticated statistical and data analysis techniques to the collected data. Since the central data collection server is connected to the Internet, dispersion of alarms and alerts is greatly facilitated.

The methods used for data analysis can be readily varied or modified by someone skilled in the art of computer programming since the raw data is easily available from the database for manipulation. For example, the analytical data, when combined with known system constants such as flow rates, residence times, and so on, can be used to continuously generate a calculated product of disinfectant concentration times contact time CT. This simple factor alone is quite useful in predicting the amount of biological organism deactivation. More sophisticated analyses can also be utilized. The results can be conveniently stored in the database and displayed as virtual sensors, meaning in this case a calculated value displayed as a sensor.

With current data and with historical data as a reference point, one can calculate a chlorine demand from the chemical dose rates, flows, and residual. Chlorine Demand is the actual amount of chlorine which is reacting, typically calculated as free chlorine dosed less the residual. Chlorine demand can be correlated with temperature, season, and filtered water turbidity. Additionally residual chlorine leaving the plant can be correlated with residual chlorine within the distribution system. If the actual chlorine residual measured at the distribution system point of measurement varies from the historical values expected from the chlorine residual leaving the treatment facility by more than a set percentage or more than a set number of standard deviations, then an alarm or alert may be issued by the monitoring system of the instant invention.

As a further example, consider the potential deliberate injection of chemically or biologically active agents into the distribution system at a point downstream of the treatment facility. A sophisticated terrorist may first inject a chlorine scavenger such as sodium metabisulfite into the distribution system to eliminate the chlorine residual normally present. At some point downstream of the metabisulfite injection point, the chemical or biological agent can be injected into the water without destruction by any residual disinfectant. Without an analytical station and monitoring system in place within the distribution system this approach could go undetected for quite some time, allowing a thorough infiltration of a biological or chemical agent throughout the distribution system. Assuming such an attack, the chlorine residual at the monitoring station would very quickly diminish to zero. A monitoring system with an active system in place to analyze the incoming data would quickly detect such an attack and sound the alarm. With historical data to compare to, the incidence of false terrorist attack alarms could be greatly diminished. For example a chlorine dosing equipment failure would be noticed at the water treatment plant providing information that a subsequent fall of chlorine concentration in the distribution system was not a terrorist attack, but an equipment failure.

In the same example of a hypothetical terrorist attack, the terrorist might try to simply overwhelm the residual chlorine in the distribution system by injecting, for example, an amount of biological or chemical agent dispersed as a fine powder in water. In this case, chlorine would fall as well but depending on the location of the sensors in relation to the injection point, the concentration might not fall to zero. However, the turbidity might well be affected. Thus a turbidity sensor in the distribution system would be an advantage in assessing a potential threat. In all cases, the need to quickly transmit raw data from both the distribution system and treatment plant to a computer system where it can be manipulated and analyzed is very important for prompt action to occur in response to any threat to the water system.

U.S. Patent Application Pub. No. US2002/0130069 discloses a method by which a monitoring unit is installed in a residential environment with detected values being transmitted to a remote monitoring station. Customers register and pay for the server over the Internet. A water quality detection unit mounted in the home includes a halocarbons in chlorine analyzer where incoming liquid is converted to gas. The detection unit also includes a UV lamp reactor and/or a chromatographic column. The combined data from the detection unit is transmitted to a wall-mounted monitoring unit in the customer's home. The monitoring unit includes a microprocessor operable to compare the data to reference values. The data is analyzed on-site by the microprocessor in the wall-mounted monitoring unit, and if unsafe parameters are detected, an alarm sounds and an alert is transmitted to a Central Monitoring Station over a computer network such as the Internet.

The present invention as disclosed herein utilizes new generation water sensors which provide “lab on a chip” technology and near real-time data transmission via an integral communication interface. Sensors such as the Six-CENSE™ and CT-CENSE™ manufactured by Dascore, Inc., as well as the multi-sensor devices manufactured by Sensicore, Inc. can measure chlorine, heavy metals, and various other constituents by concentrating the analyte through a small membrane exposed to the stream being monitored. Electric current (amperometric) or voltage readings are then converted to a value by the control electronics within the device. The water quality sensor apparatus used in these sensors is described in U.S. Pat. No. 5,483,164 issued to Moss et al., the content of which is herein incorporated by reference.

By providing a means to transmit raw data from an end user site directly to a central Internet server for analysis, the present invention provides a substantial improvement over prior art systems for the purpose of rapid detection of criminal or terrorist activity.

### SUMMARY OF THE INVENTION

The present invention is a system and method for monitoring water quality at remote locations in a water distribution system using a plurality of multi-parameter water sensor assemblies installed into water lines at end user sites. Each sensor includes an integral processing means and a communications interface. Each end user site including a communication means operable to communicate with a remotely located Internet server which can be coupled to the sensor assemblies. In a preferred embodiment, existing telephone lines at an end user site are utilized to provide a dedicated network connection. The sensor assemblies are effective for measuring critical water parameters and deriving raw data based on the parameters, processing the measured raw data to provide quantified output data, and transmitting the output data to the Internet server via the communications interface in real time or near real time.

The transmitted data is stored on the Internet server computer where it can be asynchronously accessed. The output data is manipulated into an analysis result and a report result and uploaded to an Internet web server in a format suitable for access and visualization with a web browser computer program. A processor resident on the Internet server is operable to compare the output data with pre-established safe water parameters, determine differentials between pre-established safe water parameters and the output data, and issue an Alarm Event report if known limits for the differentials are exceeded. The Alarm Event report can be automatically transmitted to pre-selected recipients, including designated law enforcement entities, such as the Department of Homeland Security. The Alarm Event report can be transmitted via file transfer protocol (.ftp), email, a wireless communication device, or any other suitable means of communication. The Internet server computer 20 can be coupled to a computer network 200 associated with a law enforcement agency, such as the Dept. of Homeland Security, whereby the Alarm Event reports are concurrently received by the law enforcement agency. A unique identifier is assigned to each of said sensor assemblies and transmitted concurrently with the output data so that the source of the output data and the physical location can be identified at the Internet server computer.

Thus, it is an objective of the invention to provide a system and method for monitoring water quality in a water distribution system at end user locations, such as private residences, businesses, etc., by installing sensor assemblies at the end user and using existing communication infrastructure present at the end user locations to transmit data to a central location via the Internet.

It is another objective to provide a system and method for monitoring water quality in a water distribution system utilizing sensor assemblies having an integral processing means and a communications interface which allow the sensor assembly to be coupled directly to an Internet server.

It is still another objective to provide a method and system for securing the water supply against possible terrorist attack by using data manipulation steps to continuously compare the current water treatment facility data with current data obtained from the distribution system to each other and to historical records of performance already stored in the database. As will be readily appreciated by those skilled in the art of data analysis, this can provide a powerful indicator of either normal response in the distribution system or out of bounds conditions that may require immediate notification of responsible parties preferably by direct contact with Homeland Security.

It is a further objective of the invention to provide a facile means to evaluate the conditions in the water treatment distribution systems as to health and safety concerns and allow this information to be shared by responsible parties via the World Wide Web.

Another objective of the instant invention is to provide a method of monitoring water treatment systems by compiling information from one or more sensor assemblies which are in direct communication with a server computer to generate operational information in near real time, if desired, which can be obtained from any location having access to the Internet. The compiled information can be accessed by regulatory or law enforcement agencies.

Another objective of the instant invention is to provide a system that operates independent of the water treatment system wherein no feedback is possible to any monitoring or control system and to transfer such information by a local Internet provider or other internet connection to a consolidating Internet address.

Yet another objective of the instant invention is to provide an Internet report system that can be viewed online or offline providing alarms by the use of current and historical records.

Still another objective of the instant invention is to provide automatic real-time transmission of sensor data, data to graph conversion, data to statistical report conversation, compliance calendars, e-mail notification of compliance and the ability to automatically file data and reports with a regulatory or law enforcement agency.

Yet another objective of the instant invention is to provide scheduled and predicted maintenance reports by the use of the current and historical records; providing emergency notification of failures, shutdowns, critical parameters, membrane damage and the like by the use of electronic mail, pager, and/or human voice calling.

Still another objective of the instant invention is to provide a method of monitoring a water distribution system which is independent and/or complimentary of the existing monitoring system.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 illustrates an exemplary network configuration of the system of the instant invention.

FIG. 2 is a pictorial representation of the various modules that make up the instant invention.

FIG. 3 is a flow diagram of the data analysis and report generator of the software.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

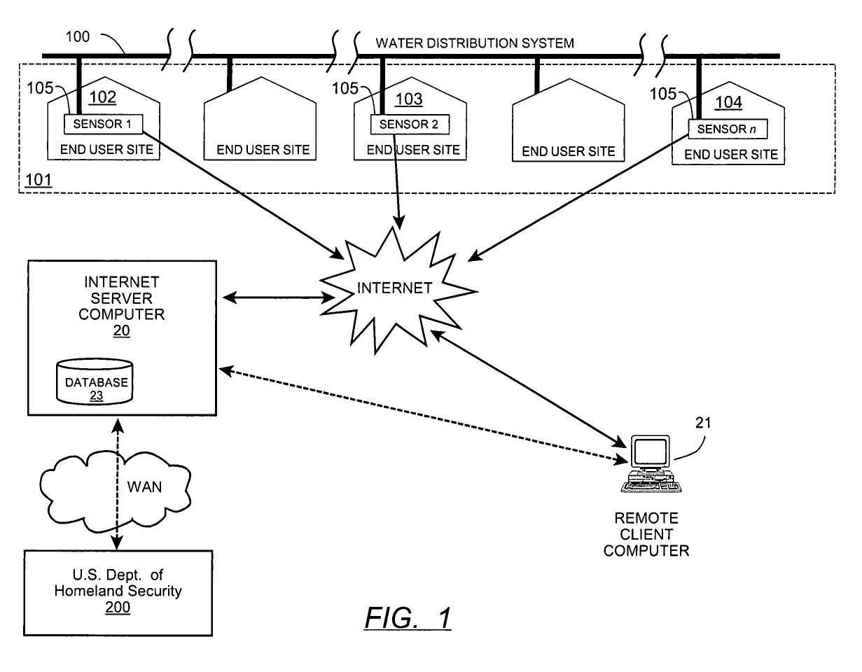

FIG. 1 pictorially illustrates an exemplary arrangement of the water quality monitoring system according to a preferred embodiment of the invention. A water distribution system 100 having a typical configuration is part of the water utility infrastructure, and serves numerous end user sites. In the present invention, sensor assemblies which each include an integral processor and a communications interfaces are installed in water conduits at end user sites such as private residences, businesses , schools, hospitals, public buildings, and the like. In accordance with the method of the invention, the existing communication infrastructure is utilized at each of the end user sites. Selected end user sites each include a communication means installed therein which is connectable to the Internet for data transfer. The communication means can be a standard Public Switched Telephone Network (PSTN), a wireless network connection, a cable Internet connection, or any suitable means which permits continuous data transfer to an Internet server. In a preferred embodiment, the sensor assemblies can be coupled to existing telephone network wiring so that no major modifications to the end user site are required.

In a preferred embodiment, the sensor assemblies include micro-sensors that incorporate chemically selective sensors and physical measurement devices on a single chip of silicon or other functional material that can chemically profile a sample as small as a drop. The sensor assemblies include a communications interface effective for real time data transmission, such as a Lonworks® network variable interface. Suitable sensors would include the Six-CENSE™ and CT-CENSE™ manufactured by Dascore, Inc., as well as the multi-sensor devices manufactured by Sensicore, Inc. These sensors can measure chlorine, heavy metals, and various other constituents by concentrating the analyte through a small membrane exposed to the stream being monitored. Electric current (amperometric) or voltage readings are then converted to a value by the control electronics within the device. Critical water parameters to be measured include, but are not limited to, free chlorine and monochloramine, dissolved oxygen, pH, conductivity, oxidation-reduction potential, temperature, color and turbidity.

In the practice of the invention, the locations of the end user sites to be fitted with sensor assemblies can be strategically selected with regard to their position in the water distribution system in order maximize the percentage of the entire system which can be continuously monitored. Referring to FIG. 1, it is seen that a plurality of end user sites in the water distribution system, generally indicated as 101, include end user sites 102, 103, and 104 which includes sensor assemblies 105₁₋ₙ installed therein to monitor water quality at the end user sites. Each of the sensor assemblies 105₁₋ₙ can be coupled to an Internet server 20 through existing telephone wiring on a dedicated network connection. In an alternative arrangement, each of the sensor assemblies can be coupled to a personal computer in communication with the Internet server 20 with data transmission from the sensor assemblies emanating from personal computer.

The sensor assemblies 105₁₋ₙ continuously monitor the water quality by measuring critical parameters and deriving the associated raw data. The raw data is quantified by the integral processor to provide output data which is continuously transmitted from the sensor assemblies to the Internet Server Computer 20. Some or all the raw data relating to the critical water parameters being monitored by a sensor can be transmitted in real time. The Internet server computer 20 includes a data storage means whereby historical data may be maintained. The Internet server computer 20 has a software application running thereon which can be accessed through a Web site from a remote client computer 21 via a Web browser. In an alternative embodiment, proprietary software can be resident on the remote client computer 21 which interfaces with the Web site on Internet Server Computer 20.

Each sensor assembly 105₁₋ₙ includes an integral transceiver which provides a electrical interface allowing the sensor assemblies 105₁₋ₙ to be networked on a communications channel. The type of transceiver component is selected to be compatible with an IP network. In the preferred embodiment, communication between the sensor assemblies 105₁₋ₙ and the Internet server 20 is achieved using the Lonworks® protocol, also known as the ANSI/EIA 709.1 Control Networking Standard. The Lonworks® protocol is a layered, packet-based peer-to-peer communications protocol which is a published standard and adheres to the International Standards Organization (ISO OSI) reference model. The protocol is media-independent, allowing devices to communicate over any physical transport media. The protocol is designed for the specific requirements of control systems, rather than data processing systems. All communications consist of one or more packets exchanged between devices and the Internet server. Each packet is a variable number is bytes in length and contains a compact representation of the data.

The sensor assemblies 105₁₋ₙ each include a semi-conductor device designed to provide networking capabilities. A preferred semi-conductor device is the Neuron Chip™ manufactured by Echelon Corporation, Cypress Semiconductor, Motorola, and Toshiba. In the preferred embodiment, the semiconductor device includes multiple processors, RAM, ROM, and communication and I/O subsystems. The ROM contains an operating system, a communications protocol (such as Lonworks®), and an I/O function library. The chip preferably includes a non-volatile memory for configuration data and the application program. The Neuron Chip™ includes three 8-bit inline processors, two of which execute the communications protocol, and a third for the operation of the sensor assembly.

Each sensor assembly 105₁₋ₙ includes a unique identifier which is resident in the processor memory. The unique identifier is transmitted to the Internet server 20 concurrently with the output data, thus allowing the precise physical location of the sensor assembly 105₁₋ₙ to be mapped so that the source of the output data can be determined. The Internet server 20 includes software algorithms to track contaminants based on the sensor assembly data and project the flow through the system so that effective responsive action can be taken. In preferred embodiment, each sensor assembly is associated with a Physical Address in the form of a unique 48-bit identifier which is assigned at the time of manufacture which does not change during the lifetime of the device. The sensor assembly is assigned a Device Address when it is installed into the network. Device Addresses can be used instead of physical addresses because they provide more efficient routing of messages, and also simplify the replacement of failed devices. Every sensor assembly on the channel looks at every packet transmitted on the channel to determine if it is the addressee. Every data packet transmitted over the network contains the Device Address of the transmitting sensor (the source address) and the address of the receiving device. In the practice of the invention, the receiving address is generally that of the Internet Server 20.

The Internet Server 20 is networked to the communications channel through a router. A preferred router is the Echelon iLON 1000™, which “tunnels” the data packet transmitted by the sensor assemblies into IP (Internet Protocol) packets. In this way, standard data transport techniques like the Internet Protocol can be used instead of proprietary protocols. The Internet Server 20 can include a transceiver to for attaching to the communications channel, and a HTTP server that can be connected to the Internet. The HTTP server provides Web pages that can be viewed from any Web browser. A preferred Internet Server is the Echelon i.LON 1000™ IP Server integrated with the Echelon i.LON ₁₀₀₀™ router.

Software resident on the Internet server 20 compares the output data received from the sensor assemblies 105₁₋ₙ with pre-established safe water parameters and determine the differentials. If known limits for the differentials are exceeded, an Alarm Event report is issued. A software algorithm resident on Internet server 20 compares the parameters to known physical, chemical, and biological properties for contaminants which are stored in a database associated with the Internet server 20. The contaminant categories can include chemical warfare agents, toxins, protozoa, bacteria and rickettsiae, and toxic industrial chemicals. The Alarm Event report may be inconclusive, based solely on abnormalities in the differentials, or can otherwise be conclusive, when a specific contaminant can be identified based on known properties.

The Alarm Event report is automatically transmitted to pre-selected recipients. The pre-selected recipients can include specific individuals, such as water utility personnel, and specific entities, such as law enforcement agencies and the U.S. Department of Homeland Security. The Alarm Event report can be transmitted via any suitable expedient means of communication, including electronic transmission methods such as .ftp (file transfer protocol) , e-mail (smtp), wireless communications devices, or public switched telephone network (e.g. via telefax). If transmitted to a personal communication device, the Alarm Event report can be in the form of a general alarm which requires the recipient to access the web site for detailed information. Referring again to FIG. 1, the Internet server 20 can be directly coupled over a wide area network to a computer network associated with a separate entity such as the Department of Homeland Security. In this way, the Alarm Event reports are concurrently received by the Department of Homeland Security.

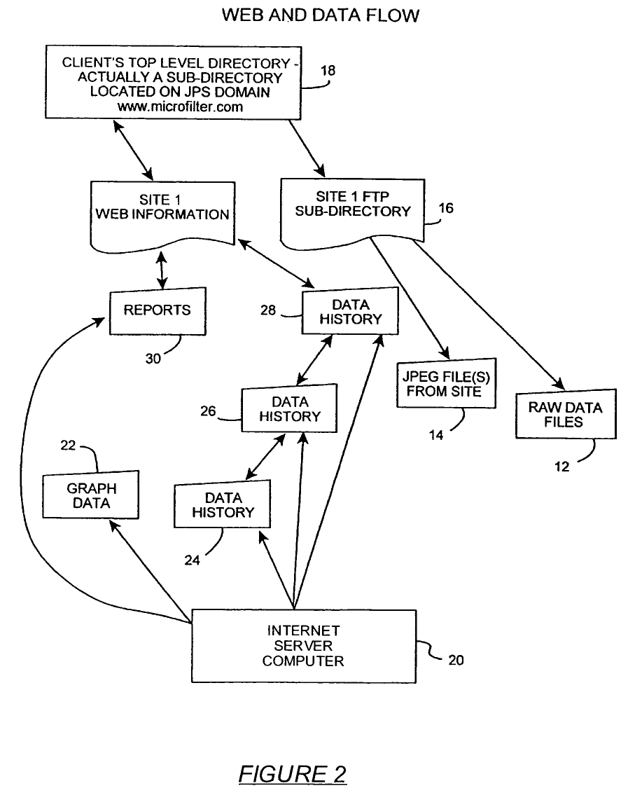

FIG. 2 graphically illustrates the flow of data. System operation is monitored in near real time by accessing an Internet web site 21. Data transmitted by the sensor assemblies is collected on the Internet server computer 20 and stored in the database computer 23, which may be one and the same as the Internet server computer or a separate computer networked to the Internet server computer 20. As will be readily appreciated by those skilled in the art, the number and location of the Internet server computer(s) 20 and the database 23 may be varied to suit the network traffic or demands of a particular client. The data collected on the Internet server computer 20 is also manipulated by the Internet server computer 20 wherein operating parameters are displayed graphically in a tabular format which may be color coded to provide an indication of normal operation, warning status or alarm conditions. The information from the sensors is used for determining critical information for the proper evaluation of the water treatment system which is normalized and graphically displayed for performance evaluation, preventative maintenance, scheduling, or for trouble shooting.

When the client accesses the web site through a user request 25 the client's credentials are compared 24 to the credentials stored in the database. If authenticated, the client may then access near real time or historical performance data which 26 can be displayed or plotted and presented also in geographical or tabular form reports 27 for selected periods. The requested reports and displays are then placed into the client's web pages for display on the client's browser 22. In the event of a contamination event, the client can access a complete report situation triggering the Alarm Event. The report can include a geographic representation of the source of the contaminant in the system based on sensor data and the projected flow through the system. In this way, rapid containment of the contaminant can be achieved.

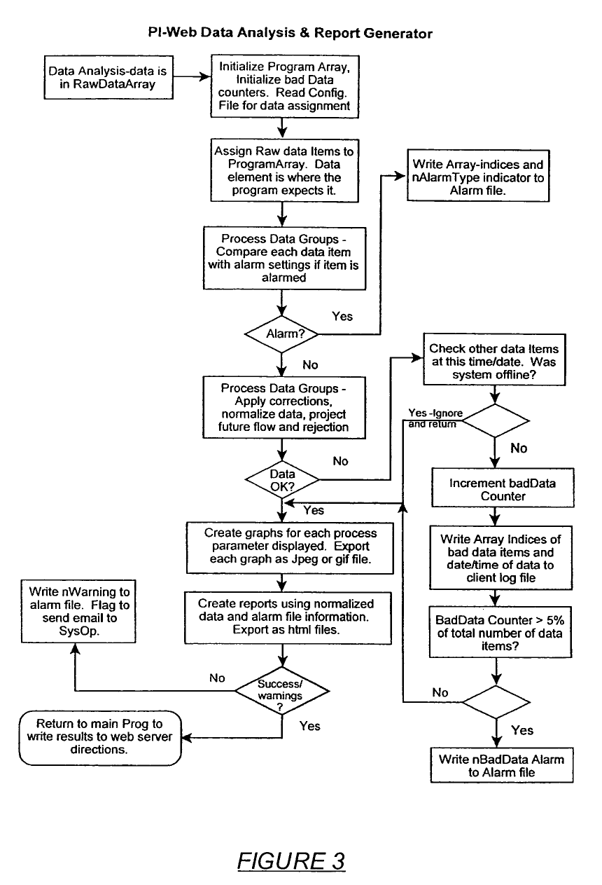

As shown in FIG. 3, data arrives from a sensor assembly and is subsequently processed by sub-programs on the Internet server computer 20. As can be easily appreciated, the Internet server computer 20 may be in actuality a plurality of separate computers or processors designed to spread the processing load as needed. The ID of the sensor assembly is validated and if validated the data is stored in the database. Appropriate unit transformations or scaling parameters may be added from information retrieved in a configuration file or stored in the database. If the sensor ID is not validated, a message is written to a log file which may also be part of the database or a separate file.

It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

I claim:

1. A method for monitoring water quality at remote locations in a water distribution system, comprising the steps of:
selecting a plurality of end user sites in the water distribution system, each end user site including a communication means operable to communicate with a remotely located Internet server;
providing a plurality of multi-parameter water sensor assemblies each having an integral processing means and a communications interface, wherein the sensor assemblies are effective for measuring critical water parameters and deriving raw data therefrom, processing measured raw data to provide quantified output data, and transmitting the output data via the communications interface;
installing the plurality of multi-parameter water sensor assemblies into a water conduit at each of the plurality of end user sites;
coupling the plurality of sensor assemblies to a remotely located Internet server computer via the communication means located at the end user site;
transmitting the output data to the Internet server computer;
storing the transmitted output data on the Internet server computer;
accessing such output data asynchronously from the Internet server computer;
manipulating the transmitted output data into an analysis result and a report result; and
uploading the analysis result and the report result to an Internet web server in a format suitable for access and visualization with a web browser computer program.

2. The method of claim 1, wherein the step of manipulating the transmitted output data into an analysis result and a report result further comprises the steps of:
comparing the output data with pre-established safe water parameters;
determining differentials between pre-established safe water parameters and the output data; and
issuing an Alarm Event report if known limits for the differentials are exceeded.

3. The method of claim 2, wherein the step of issuing an Alarm Event report further comprises the step of transmitting the Alarm Event report to pre-selected recipients.

4. The method of claim 3, wherein the Alarm Event report is transmitted to a designated law enforcement entity.

5. The method of claim 3, wherein the Alarm Event report is transmitted to the U.S. Dept. Of Homeland Security.

6. The method of claim 3, wherein the Alarm Event report is transmitted via file transfer protocol (.ftp).

7. The method of claim 3, wherein the Alarm Event report is transmitted via email.

8. The method of claim 3, wherein the Alarm Event report is transmitted via a wireless communication device.

9. The method of claim 2, further comprising the step of coupling the Internet server computer to a computer network associated with a law enforcement agency whereby the Alarm Event reports are concurrently received by the law enforcement agency.

10. The method of claim 2, further comprising the step of coupling the Internet server computer to a computer network associated with the U.S. Department of Homeland Security whereby the Alarm Event reports are concurrently received by the U.S. Department of Homeland Security.

11. The method of claim 1, wherein the plurality of sensor assemblies transmit output data in real time.

12. The method of claim 1, wherein the plurality of sensor assemblies communicate with an electronic control system.

13. The method of claim 12, wherein the electronic control system is defined as a programmable logic controller (PLC).

14. The method of claim 1, wherein the communication means at the end user site is a public switched telephone network (PSTN).

15. The method of claim 1, wherein the communication means at the end user site is a wireless communication network.

16. The method of claim 1, further comprising the steps of:
assigning a unique identifier to each of the sensor assemblies,
storing the unique identifier in the processing means of the sensor assembly; and
transmitting the unique identifier concurrently with the output data, whereby the source of the output data can be identified at the Internet server computer.

17. A system for monitoring water quality at a plurality of end user sites in a water distribution system wherein each of the end user sites are on a public switched telephone network (PSTN), comprising:
a plurality of multi-parameter water sensor assemblies each including a integral communication interface, said plurality of sensor assemblies being installed into water lines at each of the plurality of end user sites such that said communications interfaces are coupled to the PSTN at each end user site, said plurality of sensor assemblies further including a processing means wherein said sensor assemblies are effective for measuring critical water parameters and deriving raw data therefrom, processing measured raw data to provide quantified output data, and transmitting the output data via the communications interface;
a remotely located Internet server computer in communication with said plurality of sensor assemblies via a PSTN, said Internet server being in communication with a processing means and a memory means, wherein said processing means is operable to perform the steps of: storing the transmitted output data in said memory means; comparing the output data with pre-established safe water parameters; determining differentials between pre-established safe water parameters and the output data; and issuing an Alarm Event report if known limits for the differentials are exceeded; and
a means for coupling said Internet server computer to a computer network associated with a law enforcement agency whereby said Alarm Events reports are concurrently received by the law enforcement agency.

18. The system of claim 17, further comprising a communication means operable to transmit said Alarm Event report to pre-selected recipients.

19. The system of claim 18, wherein said communications means is e-mail.

20. The system of claim 18, wherein said communications means is a wireless communication network.

21. The system of claim 18, wherein the Alarm Event report is transmitted via file transfer protocol (.ftp).

22. The system of claim 17, wherein said processing means is operable to perform the steps of:
accessing output data asynchronously from the Internet server computer;
manipulating the transmitted output data into an analysis result and a report result; and
uploading the analysis result and the report result to an Internet web server in a format suitable for access and visualization with a web browser computer program.

23. The system of claim 17, wherein the plurality of sensor assemblies transmit output data in real time.

24. The system of claim 17, further comprising an electronic control system in communication with said plurality of sensor assemblies.

25. The system of claim 24, wherein the electronic control system is defined as a programmable logic controller (PLC).

26. The system of claim 17, wherein said transmitted output data from each of said sensor assemblies includes a unique identifier for each of said sensor assemblies whereby the source of said output data can be identified at said Internet server computer.

27. A method for monitoring water quality at remote locations in a water distribution system, comprising the steps of:
selecting a plurality of end user sites in the water distribution system, each end user site including a communication means operable to communicate with a remotely located Internet server;
providing a plurality of multi-parameter water sensor assemblies each having an integral processing means and a communications interface, wherein the sensor assemblies are effective for measuring critical water parameters and deriving raw data therefrom, processing measured raw data to provide quantified output data, and transmitting the output data via the communications interface;
installing the plurality of sensor assemblies into a water conduit at each of the plurality of end user sites;
coupling the plurality of sensor assemblies to a remotely located Internet server computer via the communication means located at the end user site;
transmitting the output data to the Internet server computer;
storing the transmitted output data on the Internet server computer;
comparing the output data with pre-established safe water parameters;
determining differentials between pre-established safe water parameters and the output data;
issuing an Alarm Event report if known limits for the differentials are exceeded; and
coupling the Internet server computer to a computer network associated with a law enforcement agency whereby the Alarm Event reports are concurrently received by the law enforcement agency.

28. The method of claim 27, wherein said step of issuing an Alarm Event report further comprises the step of transmitting the Alarm Event report to pre-selected recipients.

29. The method of claim 28, wherein the Alarm Event report is transmitted via email

30. The method of claim 28, wherein the Alarm Event report is transmitted via a wireless communication device.

31. The method of claim 28, wherein the Alarm Event report is transmitted via file transfer protocol (.ftp).

32. The method of claim 27, wherein the plurality of sensor assemblies transmit output data in real time.

33. The method of claim 27, wherein the plurality of sensor assemblies communicate with an electronic control system.

34. The method of claim 33, wherein the electronic control system is defined as a programmable logic controller (PLC).

35. The method of claim 27, wherein the communication means at the end user site is a public switched telephone network (PSTN).

36. The method of claim 27, wherein the communication means at the end user site is a wireless communication network.

37. The method of claim 27, further comprising the steps of:
assigning a unique identifier to each of the sensor assemblies, storing the unique identifier in the processing means of the sensor assembly; and
transmitting the unique identifier concurrently with the output data, whereby the source of the output data can be identified at the Internet server computer.

38. The method of claim 27, wherein said step of coupling the plurality of sensor assemblies to a remotely located Internet server computer via the communication means located at the end user site further comprises the steps of coupling the plurality of sensor assemblies to a personal computer in communication with the remotely located Internet server via the communication means.

39. The method of claim 38, wherein the output data is transmitted to the Internet server computer from the personal computer.
